(19) United States
(12) Patent Application Publication
(10) Pub. No.: US 2025/0133459 A1
(43) Pub. Date: Apr. 24, 2025

(54) PARAMETER DETERMINING METHOD, TERMINAL, AND NETWORK SIDE DEVICE

(71) Applicant: VIVO MOBILE COMMUNICATION CO., LTD., Dongguan (CN)

(72) Inventors: Can LI, Dongguan (CN); Siqi LIU, Dongguan (CN)

(73) Assignee: VIVO MOBILE COMMUNICATION CO., LTD., Dongguan (CN)

(21) Appl. No.: 19/006,166

(22) Filed: Dec. 30, 2024

Related U.S. Application Data
(63) Continuation of application No. PCT/CN2023/102103, filed on Jun. 25, 2023.

(30) Foreign Application Priority Data
Jul. 1, 2022 (CN) 202210775085.5

(51) Int. Cl. H04W 36/06; H04W 36/00

(52) U.S. Cl. CPC H04W 36/06; H04W 36/0083

(57) ABSTRACT

This application provides a parameter determining method, a terminal, and a network side device. The parameter determining method includes: when a terminal performs transmission on at least one of N physical units, determining, by the terminal based on target information, a target parameter used for transmission or switching. The transmission is transmission based on at least one of M transmit channels, or the transmission is transmission based on at least one of M transmit channels on a physical unit after transmit channel switching. Nis an integer greater than 2, and M is a positive integer less than or equal to N.

### CROSS-REFERENCE TO RELATED APPLICATIONS

This application is a continuation of International Application No. PCT/CN 2023/102103, filed on Jun. 25, 2023, which claims priority to Chinese Patent Application No. 202210775085.5, filed on Jul. 1, 2022. The entire contents of each of the above-referenced applications are expressly incorporated herein by reference.

### TECHNICAL FIELD

This application pertains to the field of communication technologies, and specifically, relates to a parameter determining method, a terminal, and a network side device.

### BACKGROUND

With the development of communication technologies, terminals support more and more bands. For example, in the future, terminals may support more than two uplink and/or sidelink bands.

Currently, a terminal may perform uplink sending on a maximum of two transmit channels at the same time, and the two transmit channels support switching between only two uplink bands.

### SUMMARY

Embodiments of this application provide a parameter determining method, a terminal, and a network side device.

According to a first aspect, a parameter determining method is provided, where a configuration resource of a terminal includes N physical units, and the method includes:
in a case that the terminal performs transmission on at least one of the N physical units, determining, by the terminal based on target information, a target parameter used for transmission or switching, where the transmission is transmission based on at least one of M transmit channels, or the transmission is transmission based on at least one of M transmit channels on a physical unit after transmit channel switching, N is an integer greater than 2, M is a positive integer less than or equal to N, and the target information includes at least one of the following:
a physical unit on which at least one of the M transmit channels is located;
a transmit channel included or used by at least one of the N physical units;
a quantity of at least one item of transmit channels, antenna ports, or Multiple-Input Multiple-Output (MIMO) layers supported by at least one of the N physical units;
a physical unit supported by at least one of the M transmit channels; and
a release of the terminal and/or a network side device.

According to a second aspect, a parameter determining method is provided, including:
sending, by a network side device, configuration information of target information to a terminal, where the target information is used by the terminal to determine a target parameter used for transmission or switching, where the transmission is transmission based on at least one of M transmit channels, or the transmission is transmission based on at least one of M transmit channels on a physical unit after transmit channel switching, N is an integer greater than 2, M is a positive integer less than or equal to N, and the target information includes at least one of the following:
a physical unit on which at least one of the M transmit channels is located;
a transmit channel included or used by at least one of the N physical units;
a quantity of at least one item of transmit channels, antenna ports, or MIMO layers supported by at least one of the N physical units;
a physical unit supported by at least one of the M transmit channels; and
a release of the terminal and/or the network side device.

According to a third aspect, a parameter determining apparatus is provided, applied to a terminal, where a configuration resource of the terminal includes N physical units, and the apparatus includes:
a processing module, configured to: in a case that transmission is performed on at least one of the N physical units, determine, by the terminal based on target information, a target parameter used for transmission or switching, where the transmission is transmission based on at least one of M transmit channels, or the transmission is transmission based on at least one of M transmit channels on a physical unit after transmit channel switching, N is an integer greater than 2, M is a positive integer less than or equal to N, and the target information includes at least one of the following:
a physical unit on which at least one of the M transmit channels is located;
a transmit channel included or used by at least one of the N physical units;
a quantity of at least one item of transmit channels, antenna ports, or MIMO layers supported by at least one of the N physical units;
a physical unit supported by at least one of the M transmit channels; and
a release of the terminal and/or a network side device.

According to a fourth aspect, a parameter determining apparatus is provided, including:
a sending module, configured to send configuration information of target information to a terminal, where the target information is used by the terminal to determine a target parameter used for transmission or switching, where the transmission is transmission based on at least one of M transmit channels, or the transmission is transmission based on at least one of M transmit channels on a physical unit after transmit channel switching, N is an integer greater than 2, M is a positive integer less than or equal to N, and the target information includes at least one of the following:
a physical unit on which at least one of the M transmit channels is located;
a transmit channel included or used by at least one of the N physical units;
a quantity of at least one item of transmit channels, antenna ports, or MIMO layers supported by at least one of the N physical units;
a physical unit supported by at least one of the M transmit channels; and
a release of the terminal and/or a network side device.

According to a fifth aspect, a terminal is provided. The terminal includes a processor and a memory, the memory stores a program or an instruction that can be run on the processor, and the program or the instruction is executed by the processor to implement the steps of the method according to the first aspect.

According to a sixth aspect, a terminal is provided, including a processor and a communication interface. The processor is configured to: in a case that transmission is performed on at least one of N physical units, determine, by the terminal based on target information, a target parameter used for transmission or switching, where the transmission is transmission based on at least one of M transmit channels, or the transmission is transmission based on at least one of M transmit channels on a physical unit after transmit channel switching, N is an integer greater than 2, M is a positive integer less than or equal to N, and the target information includes at least one of the following: a physical unit on which at least one of the M transmit channels is located; a transmit channel included or used by at least one of the N physical units; a quantity of at least one item of transmit channels, antenna ports, or MIMO layers supported by at least one of the N physical units; a physical unit supported by at least one of the M transmit channels; and a release of the terminal and/or a network side device.

According to a seventh aspect, a network side device is provided. The network side device includes a processor and a memory, the memory stores a program or an instruction that can be run on the processor, and the program or the instruction is executed by the processor to implement the steps of the method according to the second aspect.

According to an eighth aspect, a network side device is provided, including a processor and a communication interface. The communication interface is configured to send configuration information of target information to a terminal, where the target information is used by the terminal to determine a target parameter used for transmission or switching, where the transmission is transmission based on at least one of M transmit channels, or the transmission is transmission based on at least one of M transmit channels on a physical unit after transmit channel switching, N is an integer greater than 2, M is a positive integer less than or equal to N, and the target information includes at least one of the following: a physical unit on which at least one of the M transmit channels is located; a transmit channel included or used by at least one of the N physical units; a quantity of at least one item of transmit channels, antenna ports, or MIMO layers supported by at least one of the N physical units; a physical unit supported by at least one of the M transmit channels; and a release of the terminal and/or a network side device.

According to a ninth aspect, a communication system is provided, including a terminal and a network side device. The terminal may be configured to perform the steps of the parameter determining method according to the first aspect, and the network side device may be configured to perform the steps of the parameter determining method according to the second aspect.

According to a tenth aspect, a readable storage medium is provided. The readable storage medium stores a program or an instruction, and the program or the instruction is executed by a processor to implement the steps of the method according to the first aspect or the steps of the method according to the second aspect.

According to an eleventh aspect, a chip is provided. The chip includes a processor and a communication interface, the communication interface is coupled to the processor, and the processor is configured to run a program or an instruction to implement the method according to the first aspect or the method according to the second aspect.

According to a twelfth aspect, a computer program/program product is provided. The computer program/program product is stored in a storage medium, and the computer program/program product is executed by at least one processor to implement the steps of the parameter determining method according to the first aspect or the second aspect.

In the embodiments of this application, in a case that a terminal performs transmission on at least one of two physical units, the transmission may be based on at least one of M transmit channels, or the transmission may be based on at least one of M transmit channels on a physical unit after transmit channel switching. The terminal may determine, based on target information, a target parameter used for transmission or switching, so that a scheme of determining, based on the target information, the target parameter used for transmission or switching is implemented in a scenario in which transmission or transmit channel switching on more than two physical units is supported.

### BRIEF DESCRIPTION OF DRAWINGS

FIG. 1 is a structural diagram of a wireless communication system to which the embodiments of this application can be applied;

FIG. 2a is a first schematic diagram of an uplink Tx switching case that supports EN-DC and inter-CA according to an embodiment of this application;

FIG. 2b is a second schematic diagram of an uplink Tx switching case that supports EN-DC and inter-CA according to an embodiment of this application;

FIG. 2c is a third schematic diagram of an uplink Tx switching case that supports EN-DC according to an embodiment of this application;

FIG. 2d is a fourth schematic diagram of an uplink Tx switching case that supports EN-DC according to an embodiment of this application;

FIG. 3a is a first schematic diagram of an uplink Tx switching case that supports inter-CA according to an embodiment of this application;

FIG. 3b is a first schematic diagram of an uplink Tx switching case that supports inter-CA according to an embodiment of this application;

FIG. 4 is a first schematic diagram of an uplink Tx switching case that supports SUL according to an embodiment of this application;

FIG. 5a is a first schematic diagram of a switching period according to an embodiment of this application;

FIG. 5b is a second schematic diagram of a switching period according to an embodiment of this application;

FIG. 6 is a first schematic flowchart of a parameter determining method according to an embodiment of this application;

FIG. 7 is a schematic diagram of a switching period and a downlink interruption time in a parameter determining method according to an embodiment of this application;

FIG. 8 is a second schematic flowchart of a parameter determining method according to an embodiment of this application;

FIG. 9 is a first schematic structural diagram of a parameter determining apparatus according to an embodiment of this application;

FIG. 10 is a second schematic structural diagram of a parameter determining apparatus according to an embodiment of this application;

FIG. 11 is a schematic structural diagram of a communication device according to an embodiment of this application;

FIG. 12 is a schematic structural diagram of hardware of a terminal according to an embodiment of this application; and

FIG. 13 is a schematic structural diagram of hardware of a network side device according to an embodiment of this application.

### DETAILED DESCRIPTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill based on the embodiments of this application shall fall within the protection scope of this application.

In the specification and claims of this application, the terms “first”, “second”, and the like are intended to distinguish between similar objects but do not describe a specific order or sequence. It should be understood that the terms used in such a way are interchangeable in proper circumstances so that the embodiments of this application can be implemented in orders other than the order illustrated or described herein. Objects classified by “first” and “second” are usually of a same type, and the number of objects is not limited. For example, there may be one or more first objects. In addition, in the specification and claims, “and/or” represents at least one of connected objects, and a character “/” generally represents an “or” relationship between associated objects.

It should be noted that technologies described in the embodiments of this application are not limited to a Long Time Evolution (LTE)/LTE-Advanced (LTE-A) system, and may further be applied to other wireless communication systems such as Code Division Multiple Access (CDMA), Time Division Multiple Access (TDMA), Frequency Division Multiple Access (FDMA), Orthogonal Frequency Division Multiple Access (OFDMA), Single-carrier Frequency Division Multiple Access (SC-FDMA), and other systems. The terms “system” and “network” in the embodiments of this application may be used interchangeably. The technologies described can be applied to both the systems and the radio technologies mentioned above as well as to other systems and radio technologies. The following describes a New Radio (NR) system for example purposes, and NR terms are used in most of the following descriptions. These technologies can also be applied to applications other than an NR system application, such as a 6th Generation (6G) communication system.

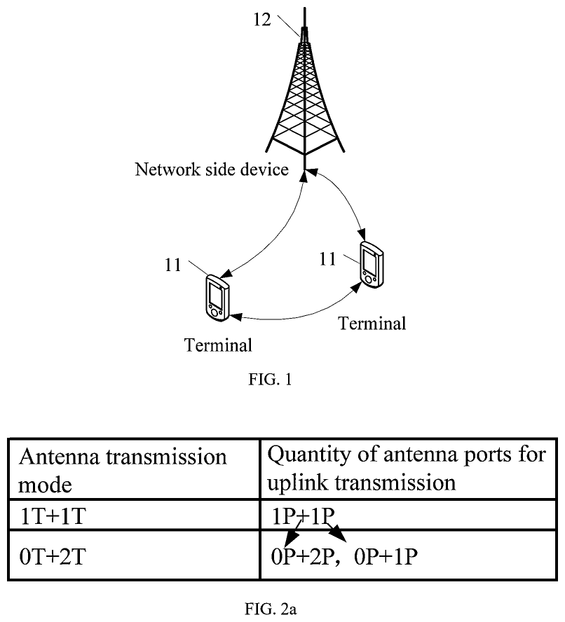

FIG. 1 is a block diagram of a wireless communication system to which the embodiments of this application can be applied. The wireless communication system includes a terminal 11 and a network side device 12. The terminal 11 may be a terminal side device such as a mobile phone, a tablet personal computer, a laptop computer or a notebook computer, a Personal Digital Assistant (PDA), a palmtop computer, a netbook, an Ultra-mobile Personal Computer (UMPC), a Mobile Internet Device (MID), an Augmented Reality (AR)/Virtual Reality (VR) device, a robot, a wearable device, Vehicle User Equipment (VUE), Pedestrian User Equipment (PUE), a smart home (a home device with a wireless communication function, such as a refrigerator, a television, a washing machine, or a furniture), a game console, a Personal Computer (PC), a teller machine, or a self-service machine. The wearable device includes a smart watch, a smart band, a smart headset, smart glasses, smart jewelry (a smart bangle, a smart bracelet, a smart ring, a smart necklace, a smart anklet, and a smart chain), a smart wrist strap, a smart dress, and the like. It should be noted that a specific type of the terminal 11 is not limited in the embodiments of this application. The network side device 12 may include an access network device or a core network device. The access network device 12 may also be referred to as a radio access network device, a Radio Access Network (RAN), a radio access network function, or a radio access network unit. The access network device 12 may include a base station, a WLAN access point, a Wi-Fi node, or the like. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home evolved NodeB, a Transmitting Receiving Point (TRP), or another appropriate term in the field. As long as a same technical effect is achieved, the base station is not limited to a specified technical term. It should be noted that, in this application, only a base station in an NR system is used as an example, and a specific type of the base station is not limited. The core network device may include but is not limited to at least one of the following: a core network node, a core network function, a Mobility Management Entity (MME), an Access and Mobility Management Function (AMF), a Session Management Function (SMF), a User Plane Function (UPF), a Policy Control Function (PCF), a Policy and Charging Rules Function (PCRF), an Edge Application Server Discovery Function (EASDF), Unified Data Management (UDM), a Unified Data Repository (UDR), a Home Subscriber Server (HSS), a Centralized network configuration (CNC), a Network Repository Function (NRF), a Network Exposure Function (NEF), a Local NEF (L-NEF), a Binding Support Function (BSF), an Application Function (AF), and the like. It should be noted that, in the embodiments of this application, only a core network device in an NR system is used as an example for description, and a specific type of the core network device is not limited.

First, related concepts in the embodiments of this application are described.

In the R16, a mechanism of uplink transmit channel switching (UL Tx switching) is introduced. That is, one terminal can perform sending on a maximum of two transmit channels Tx at the same time, one carrier supports one uplink transmit channel (for example, a carrier 1), and another carrier supports two transmit channels (for example, a carrier 2), where the carrier 1 and the carrier 2 are on different bands, and switching between two modes is supported through Tx switching. Mode 1: Uplink dual-stream transmission is performed on the carrier 2. Mode 2: Single-stream transmission is performed on the carrier 1 and/or the carrier 2.

Based on whether uplink transmission is supported on the carrier 1 and the carrier 2 at the same time, there is an option 1 (a network configures an upper-layer parameter uplinkTxSwitchingOption-r16 as switchedUL, indicating that uplink transmission cannot be performed on the carrier 1 and the carrier 2 at the same time) and an option 2 (a network configures an upper-layer parameter uplinkTxSwitchingOption-r16 as dualUL, indicating that uplink transmission can be performed on the carrier 1 and the carrier 2 at the same time).

The UL Tx switching supported by the R16 is as follows:

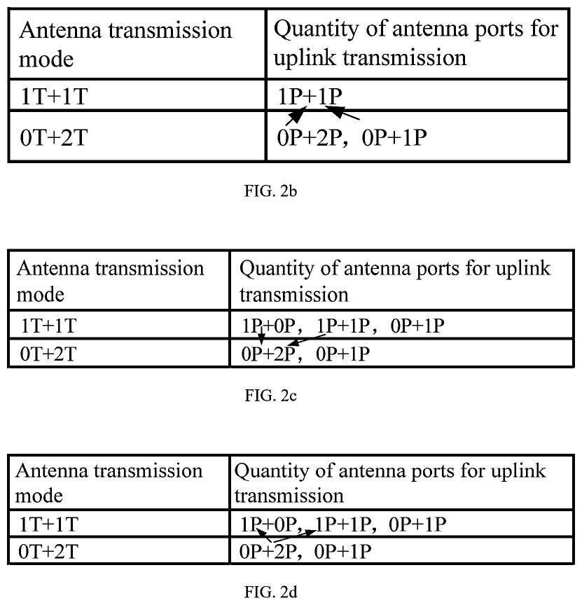

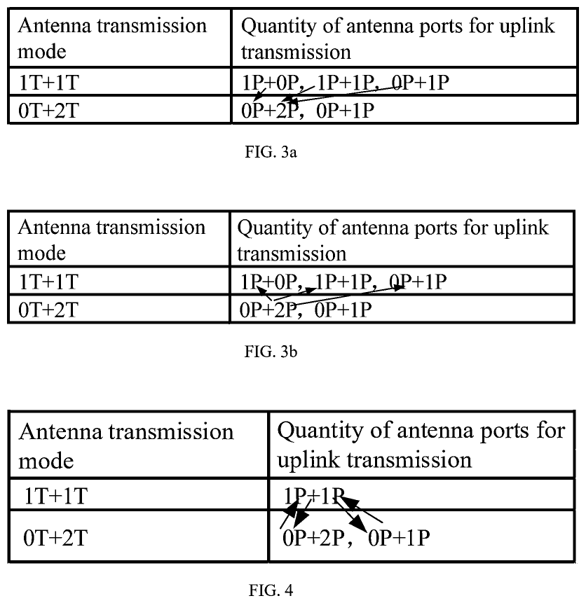

First, it should be noted that 1T+1T represents that the carrier 1 has 1Tx and the carrier 2 has 1Tx; and 1P+0P represents that the carrier 1 has one antenna port for sending, and the carrier 2 has no antenna port for sending (that is, no data is sent). It may be considered that 1Tx supports a maximum of one antenna port for sending. In FIG. 2a to FIG. 2d, FIG. 3a to FIG. 3b, and FIG. 4, arrows represent before Tx switching and after Tx switching.
1. For LTE-NR dual connectivity (E-UTRA-NR Dual Connectivity (EN-DC)), the option 1 and the option 2 are supported. A protocol specifies that an E-UTRA uplink carrier is the carrier 1 and an NR uplink carrier is the carrier 2. The option 1 is shown in FIG. 2a and FIG. 2b, and the option 2 is shown in FIG. 2c and FIG. 2d.
2. For inter-Carrier Aggregation (inter-CA), the option 1 and the option 2 are supported. Two carriers for carrier aggregation are configured by the as the carrier 1 or the carrier 2. The option 1 is shown in FIG. 2a and FIG. 2b, and the option 2 is shown in FIG. 3a and FIG. 3b.
3. For a Supplementary Uplink Carrier (SUL), only the option 1 is supported. The SUL or UL is configured by the network as the carrier 1 or the carrier 2, as shown in FIG. 4.

### Terminal Reporting Capability

The terminal reports whether the option 1 or the option 2 is supported or both are supported through a parameter uplinkTxSwitching-OptionSupport, reports a period required for UL Tx switching through a parameter uplinkTxSwitchingPeriod, and reports a band that supports downlink interruption through a parameter uplinkTxSwitching-DL-Interruption.

A network upper-layer parameter uplinkTxSwitchingOption is used to configure the terminal to support the option 1 or the option 2, uplinkTxSwitching is used to configure whether the serving cell is used for UL Tx switching, and uplinkTxSwitchingPeriodLocation is used to configure a cell associated with a switching period (for example, a switching period, a start location, and an end location) and is used to determine a location of the switching period. As shown in FIG. 5a, the switching period is located in the carrier 1, and as shown in FIG. 5b, the switching period is located in the carrier 2.
uplinkTxSwitchingCarrier is used to configure a carrier as the carrier 1 or the carrier 2 and is used to determine a quantity of supported ports and a switching mode.

A downlink interruption time length is related to a switching time length, as shown in Table 1 below. A start location of a downlink interruption time is the first OFDM symbol that overlaps a start moment of a switching period.

TABLE 1

| NR slot | |
|---|---|
| length | Uplink Tx switching period |

| μ | (ms) | 35 us | 140 us | 210 us |
|---|---|---|---|---|
| 0 | 1 | 2 | 3 | 4 |
| 1 | 0.5 | 3 | 6 | 7 |
| 2 | 0.25 | 4 | 10 | 14 |

The uplink Tx switching period depends on the terminal capability.

Further, in the R17 phase, inter-CA and SUL switching is extended. First, 2Tx-2Tx switching is supported, that is, switching between two Txs is supported on two carriers. Further, Tx switching between one carrier on a band A and two consecutive carriers on a band B (sending may be performed on the two carriers by using a same Tx) is further supported. In addition, two new Radio Resource Control (RRC) parameters are introduced, where one parameter is used to indicate a 1Tx−2Tx switching mode or a 2Tx−2Tx switching mode, so as to determine whether a 1Tx−2Tx or 2Tx−2Tx switching parameter is used; and when a Tx state is not unique after UL Tx switching, one parameter is used to indicate that the Tx state is 1Tx+1Tx or the Tx state is 0Tx+2Tx. For example, when uplinkTxSwitchingPeriod2T2T-r17 is configured, the terminal supports 2Tx−2Tx switching, and the configured switching period is determined by using uplinkTxSwitchingPeriod2T2T-r17. If the parameter is not configured (that is, a value of the parameter is null), the configured switching period is determined by using uplinkTxSwitchingPeriod-r16. It should be noted that switching modes supported by 1Tx−2Tx and 2Tx−2Tx are partially overlapping, that is, some switching modes may belong to 1Tx−2Tx and also 2Tx−2Tx, and a difference is that switching parameters of different modes are different.

Currently, the terminal may perform uplink sending on a maximum of two transmit channels at the same time, and the two transmit channels support switching between only two uplink UL bands. In the future, the terminal may support more than two uplink and/or sidelink bands.

With reference to the accompanying drawings, the following describes in detail the parameter determining method provided in the embodiments of this application by using some embodiments and application scenarios thereof.

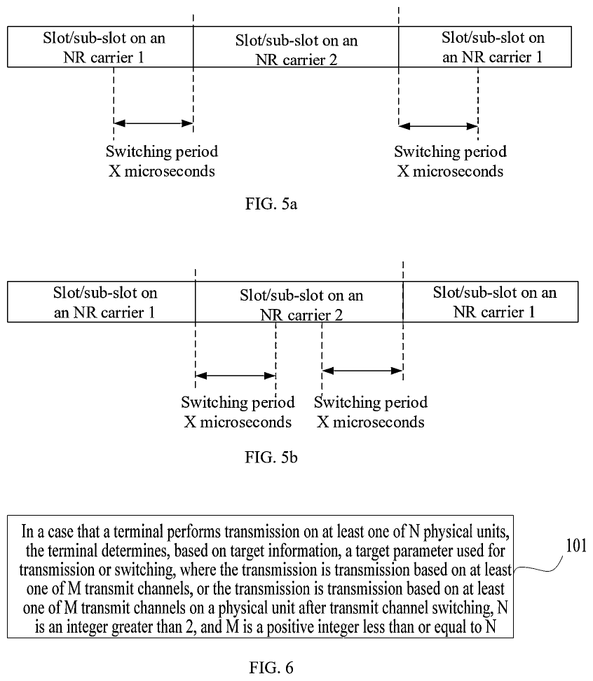

FIG. 6 is a first schematic flowchart of a parameter determining method according to an embodiment of this application. As shown in FIG. 6, the method provided in this embodiment includes the following steps:
Step 101: In a case that a terminal performs transmission on at least one of N physical units, the terminal determines, based on target information, a target parameter used for transmission or switching, where the transmission is transmission based on at least one of M transmit channels, or the transmission is transmission based on at least one of M transmit channels on a physical unit after transmit channel switching, N is an integer greater than 2, M is a positive integer less than or equal to N, and the target information includes at least one of the following:
a physical unit on which at least one of the M transmit channels is located;
a transmit channel included or used by at least one of the N physical units;
a quantity of at least one item of transmit channels, antenna ports, or MIMO layers supported by at least one of the N physical units;
a physical unit supported by at least one of the M transmit channels; and
a release of the terminal and/or a network side device.

In some embodiments, a configuration resource of the terminal includes N physical units, where the physical unit is, for example, a carrier, a band, a BWP, or a resource pool. The terminal performs transmission on at least one of N (N>2) physical units, where the transmission is transmission based on at least one of M transmit channels, or the transmission is transmission based on at least one of M transmit channels on a physical unit after transmit channel switching, where M is less than or equal to N. The terminal determines, based on the target information, the target parameter used for transmission or switching, where a physical unit supported by a transmit channel in the target information means that data of the physical unit may be transmitted by using the transmit channel. For example, if Tx1 supports {band 1, band 2, and band 3}, it indicates that data of the band 1, the band 2, and the band 3 may be transmitted by using the transmit channel Tx1, and if Tx2 supports {band 1, band 2}, it indicates that data of the band 1 and the band 2 may be transmitted by using the transmit channel Tx2. A transmit channel supported by a physical unit is a transmit channel that can be used when the physical unit sends data. For example, if a physical unit 1 supports Tx1, it indicates that the physical unit 1 can send data by using the transmit channel Tx1, and if a physical unit 2 supports Tx1 and Tx2, it indicates that the physical unit 2 can send data by using the transmit channels Tx1 and Tx2.

A physical unit in which a transmit channel is located is a physical unit including or using the transmit channel, a physical unit including the transmit channel represents a physical unit that has the transmit channel, and a physical unit using the transmit channel represents a physical unit that has the transmit channel and that uses the transmit channel to send data.

The release of the terminal and/or the network side device is, for example, a terminal and/or a network side device that support the R16, R17, and/or R18 protocols.

The terminal may determine, based on the target information and a current state of the terminal, for example, capability information of the terminal and a network state in which the terminal is located, the target parameter used for transmission or transmit channel switching.

It should be noted that the N physical units may be configured, for example, by using different types of physical units. For example, the terminal is configured with three carriers, and the three carriers are on two bands. Therefore, the N physical units may be two bands.

According to the method in this embodiment, in a case that a terminal performs transmission on at least one of two physical units, the transmission may be based on at least one of M transmit channels, or the transmission may be based on at least one of M transmit channels on a physical unit after transmit channel switching. The terminal may determine, based on target information, a target parameter used for transmission or switching, so that a scheme of determining, based on the target information, the target parameter used for transmission or switching is implemented in a scenario in which transmission or transmit channel switching on more than two physical units is supported.

In some embodiments, the target information is determined based on the capability information of the terminal and/or is configured by the network side device.

In some embodiments, the physical unit includes at least one of the following: a carrier, a bandwidth part BWP, a band, or a resource pool.

In some embodiments, step 101 may be implemented in the following manner:

The terminal determines the target parameter based on a correspondence between the target information and a parameter and based on the target information corresponding to the terminal.

In some embodiments, the terminal determines the target parameter based on the correspondence between the target information and the parameter and based on a current state of the terminal, that is, the target information corresponding to the terminal.

In some embodiments, the correspondence is determined based on the capability information of the terminal, configured by the network side device, and/or specified in a protocol.

For example, the terminal reports a supported transmission or switching type and other capability information, and the transmission or switching type may be in a one-to-one correspondence with the target parameter. The terminal determines the target parameter based on actual transmission or Tx switching.

In some embodiments, in a case that the correspondence is configured by the network side device, the correspondence is configured by the network side device based on the capability information reported by the terminal.

For example, the network side device supplements content of the correspondence based on the capability information reported by the terminal, or the network side device directly configures the correspondence based on the capability information of the terminal.

In the foregoing implementation, the terminal may directly determine the corresponding target parameter based on actual transmission or switching and the correspondence, so as to quickly determine the target parameter. Therefore, processing complexity of the terminal is reduced, and a processing delay of transmission or switching is relatively small.

In some embodiments, a quantity of physical units on which at least one of the M transmit channels is located meets at least one of the following:
a quantity of physical units including transmit channels before transmit channel switching is equal to, greater than, or less than a first threshold;
a quantity of physical units using transmit channels before transmit channel switching is equal to, greater than, or less than a second threshold;
a quantity of physical units including transmit channels after transmit channel switching is equal to, greater than, or less than a third threshold;
a quantity of physical units using transmit channels after transmit channel switching is equal to, greater than, or less than a fourth threshold;
a total quantity of physical units including transmit channels before and after transmit channel switching is equal to, greater than, or less than a fifth threshold;
a total quantity of physical units using transmit channels before and after transmit channel switching is equal to, greater than, or less than a sixth threshold;
a sum of a quantity of physical units including transmit channels before transmit channel switching and a quantity of physical units including transmit channels after a transmission change, a scheduling change, or switching is equal to, greater than, or less than a seventh threshold; and
a sum of a quantity of physical units using transmit channels before transmit channel switching and a quantity of physical units using transmit channels after transmit channel switching is equal to, greater than, or less than an eighth threshold, where
the physical unit including a transmit channel represents a physical unit that has a transmit channel, and the physical unit using a transmit channel represents a physical unit that has a transmit channel and uses the transmit channel to send data.

In some embodiments, the target parameter is related to a quantity of physical units in which Tx is located, and the quantity of physical units in which Tx is located meets at least one of the foregoing items. For example, if a quantity of physical units including Tx before transmit channel Tx switching is N1, and a quantity of physical units including Tx after transmit channel Tx switching is N2, a sum of the quantity of physical units including Tx before transmit channel Tx switching and a quantity of physical units including Tx after a transmission change, a scheduling change, or Tx switching is equal to N1+N2, and a total quantity of physical units including Tx before and after transmit channel Tx switching is less than or equal to N1+N2, because there may be duplicate physical units in the physical unit including Tx before transmit channel Tx switching and the physical units including Tx after transmit channel Tx switching.

For example, if physical units including Tx before Tx switching are {band A, band B} and a quantity of physical units including Tx before Tx switching is 2, and physical units including Tx after Tx switching are {band A, band C} and a quantity of physical units including Tx after Tx switching is 2, a total quantity of physical units including transmit channels before and after switching is 3, and a sum of the quantity of physical units including Tx before Tx switching and the quantity of physical units including Tx after Tx switching is 4.

The Tx may be represented as any Tx or a preset specific Tx.

The first threshold to the eighth threshold may be determined by the terminal, configured by the network side device, or predetermined in a protocol.

The first threshold to the eighth threshold may be the same or different. In some embodiments, the first threshold to the fourth threshold may respectively have one or more values, and may be applicable to different scenarios.

In some embodiments, the target parameter is related to an index of a physical unit in which Tx is located, and an index of the physical unit on which the at least one of the M transmit channels is located meets at least one of the following:
indexes of physical units including transmit channels before and after transmit channel switching are totally the same;
indexes of physical units using transmit channels before and after transmit channel switching are totally the same;
at least one of indexes of physical units including transmits channel before and after transmit channel switching is the same;
at least one of indexes of physical units using transmit channels before and after transmit channel switching is the same;
indexes of physical units including transmit channels before and after transmit channel switching are totally different; and
indexes of physical units using transmit channels before and after transmit channel switching are totally different.

For example, if physical units including Tx before Tx switching are {band A, band B} and indexes are {1, 2}, and physical units including Tx after switching are {band A, band C} and indexes are {1, 3}, there is the same index 1.

In some embodiments, the target parameter is related to a quantity of transmit channels included or used by a physical unit, and a quantity of transmit channels included or used by at least one of the N physical units meets at least one of the following:
a quantity of transmit channels included in a physical unit before transmit channel switching is equal to, greater than, or less than a ninth threshold;
a quantity of transmit channels used by a physical unit before transmit channel switching is equal to, greater than, or less than a tenth threshold;
a quantity of transmit channels included in a physical unit after transmit channel switching is equal to, greater than, or less than an eleventh threshold;
a quantity of transmit channels used by a physical unit after transmit channel switching is equal to, greater than, or less than a twelfth threshold;
a total quantity of transmit channels included in a physical unit before and after transmit channel switching is equal to, greater than, or less than a thirteenth threshold; and
a total quantity of transmit channels used by a physical unit before and after transmit channel switching is equal to, greater than, or less than a fourteenth threshold.

The ninth threshold to the fourteenth threshold may be determined by the terminal, configured by the network side device, or predetermined in a protocol.

The ninth threshold to the fourteenth threshold may be the same or different. In some embodiments, the ninth threshold to the fourteenth threshold may respectively have one or more values, and may be applicable to different scenarios.

The foregoing physical unit may be represented as any physical unit or a preset specific physical unit.

The foregoing transmit channel switching may occur in a case that a transmission situation of the terminal changes (or a scheduling situation changes), and that a transmission situation changes or a scheduling situation changes means that, for example, a transmission situation or a scheduling situation of a physical unit and/or a transmit channel changes.

In some embodiments, the target parameter is related to a quantity (for example, a maximum quantity) of physical units supported by Tx, and a quantity of physical units supported by at least one of the M transmit channels meets:
a maximum quantity of physical units supported by the at least one transmit channel is a fifteenth threshold.

In some embodiments, the at least one transmit channel may be any transmit channel or a preset transmit channel, for example, may be determined by the terminal, configured by the network side device, or predetermined in a protocol.

For example, the fifteenth threshold may be determined by the terminal, configured by the network side device, or predetermined in a protocol.

In some embodiments, the target parameter is related to an index of a physical unit supported by Tx, and an index of the physical unit supported by the at least one of the M transmit channels meets:
the index of the physical unit supported by the at least one transmit channel belongs to a first index set.

In some embodiments, the at least one transmit channel may be any transmit channel or a preset transmit channel, for example, may be determined by the terminal, configured by the network side device, or predetermined in a protocol.

The index of the physical unit supported by the at least one transmit channel may be a preset index, or belongs to a preset range, for example, the first index set, where the first index set may be determined by the terminal, configured by the network side device, or predetermined in a protocol.

In some embodiments, the target parameter is related to a quantity (for example, a maximum quantity) of Tx/antenna ports/MIMO layers supported by a physical unit, and the quantity of at least one item of transmit channels, antenna ports, or MIMO layers supported by the at least one of the N physical units meets:
a maximum quantity of transmit channels supported by the at least one physical unit is a sixteenth threshold;
a maximum quantity of antenna ports supported by the at least one physical unit is a seventeenth threshold; and
a maximum quantity of MIMO layers supported by the at least one physical unit is an eighteenth threshold.

In some embodiments, the at least one physical unit may be any physical unit or a preset physical unit, for example, may be determined by the terminal, configured by the network side device, or predetermined in a protocol.

The sixteenth threshold to the eighteenth threshold may be determined by the terminal, configured by the network side device, or predetermined in a protocol.

In some embodiments, the target parameter is related to the release of the terminal and/or the network side device.

In some embodiments, the parameter includes at least one of the following:
at least one physical unit for transmission or switching;
switching period information required for transmit channel switching, where the switching period information includes at least one of the following: duration, a start time, and an end time;
downlink interruption time information required for transmit channel switching, where the downlink interruption time information includes at least one of the following: duration, a start time, and an end time;
a transmission or switching type;
a capability of transmit channel parallel switching and/or serial switching;
a maximum quantity of transmission or switching periods in a preset time range;
a physical unit with downlink interruption in a process of transmit channel switching; and
a physical unit associated with switching period information.

In some embodiments, the at least one physical unit for transmission or switching may be a physical unit, a physical unit pair, a physical unit combination, or a physical unit list.

In some embodiments, the transmission or switching type includes a type of whether simultaneous transmission and/or switching are/is supported between different physical units.

The physical unit associated with the switching period information may be used to determine a start time location and/or an end time location (for example, a start slot/symbol location and/or an end slot/symbol location) of a switching period. Reference may be made to FIG. 5a and FIG. 5b.

The parallel switching may include at least one of the following cases:
switching periods of different Tx switching may at least partially overlap;
an interval between switching periods of different Tx switching is less than or equal to a threshold T1;
other Tx switching or switching trigger is allowed within a first preset time range after switching is triggered;
other Tx switching or switching trigger is allowed within a second preset time range before the start or the end of transmission after switching; and
other Tx switching or switching trigger is allowed within a third preset time range after the start of transmission after switching.

In some embodiments, duration from the first preset time range to the third preset time range may be 0, that is, it is essentially equivalent to that the first preset time range to the third preset time range do not exist.

The serial switching may include at least one of the following cases:
switching periods of different Tx switching are at least partially non-overlapping (for example, totally non-overlapping);
an interval between switching periods of different Tx switching is greater than or equal to a threshold T2;
other Tx switching or switching trigger is not allowed within a fourth preset time range after switching is triggered;
other Tx switching or switching trigger is not allowed within a fifth preset time range before the start or the end of transmission after switching; and
other Tx switching or switching trigger is not allowed within a sixth preset time range after the start of transmission after switching.

In some embodiments, duration from the fourth preset time range to the sixth preset time range may be 0, that is, it is essentially equivalent to that the fourth preset time range to the sixth preset time range do not exist.

The target parameter may be a specific value corresponding to at least one of the foregoing parameters.

In some embodiments, the foregoing parameter is determined based on the capability information of the terminal, and/or configured by the network side device.

In some embodiments, the foregoing parameter is reported and/or configured based on each target unit. The target unit includes at least one of the following: a physical unit pair, a physical unit list, or a physical unit combination.

In some embodiments, the foregoing parameter is determined based on the capability information of the terminal, or is configured by the network side device, or is configured by the network side device based on the capability information of the terminal.

For example, the terminal reports, based on a band pair (that is, a fine granularity), a parameter used for transmission or Tx switching, and the network side device configures, based on a band list or a band combination (that is, a coarse granularity), a parameter used for transmission or Tx switching. The band list includes three bands. The terminal reports, based on each band pair between the three bands, parameters used for transmission or Tx switching, and the network side device configures the most loose and/or strictest parameter in the parameters, for example, maximum/minimum switching duration.

In some embodiments, the downlink interruption time information is related to at least one of the following:
a physical unit with downlink interruption, switching period information, or a physical unit associated with switching period information.

In some embodiments, a start location of a downlink interruption time is related to a start location of the switching period, and a start slot of the downlink interruption time is the first slot that overlaps the start location of the switching period.

In some embodiments, at least one target unit corresponding to the terminal has a same physical unit with downlink interruption; or
each of at least one target unit corresponding to the terminal respectively has a physical unit with downlink interruption.

In some embodiments, for all physical units configured for the terminal, physical units with downlink interruption in a switching process are the same.

For each target unit (for example, a physical unit pair) configured for the terminal, physical units with downlink interruption in a switching process may be separately set, and may be the same or different.

In some embodiments, at least one target unit corresponding to the terminal has same switching period information; or
each of at least one target unit corresponding to the terminal respectively has switching period information.

In some embodiments, for all physical units configured for the terminal, the switching period information is the same, that is, Tx switching is performed in a unified period of time.

For each target unit (for example, a physical unit pair) configured for the terminal, the switching period information is separately set, for example, may be the same or different, that is, Tx switching is performed at a separate period of time.

In some embodiments, at least one target unit corresponding to the terminal has a same physical unit associated with switching period information; or
each of at least one target unit corresponding to the terminal respectively has a physical unit associated with switching period information.

In some embodiments, for all physical units configured for the terminal, physical units associated with switching period information are the same.

For each target unit (for example, a physical unit pair) configured for the terminal, physical units associated with switching period information are separately set, for example, may be the same or different.

For example, in the following several cases, different target parameters are separately configured.

When M=2 and N=3, the terminal is configured with three uplink carriers (carrier 1, carrier 2, carrier 3), which are respectively on three bands (band A, band B, band C).

Example 1: As shown in Table 2 and Table 3, Table 2 may represent switching from Case 2 to Case 1 or switching from Case 1 to Case 2, and Table 3 may represent switching from Case 5 to Case 3 or switching from Case 3 to Case 5. A quantity of bands including Tx before Tx switching is equal to 2, and a quantity of bands including Tx after Tx switching is equal to 1. A maximum of one Tx is on one of the band A and the band B, and the other band supports two Txs.

TABLE 2

| | Quantity of | Quantity of antenna ports for uplink |
|---|---|---|
| | switching | transmission (band A (carrier 1) + band B |
| | channels | (carrier 2) + band C (carrier 3)) |
| Case 1 | 1T + 1T + 0T | 1P + 0P + 0P, 0P + 1P + 0P, 1P + 1P + 0P |
| | | (option 2) |
| Case 2 | 0T + 2T + 0T | 0P + 2P + 0P, 0P + 1P + 0P |

TABLE 3

| | Quantity of | Quantity of antenna ports for uplink |
|---|---|---|
| | switching | transmission (band A (carrier 1) + band B |
| | channels | (carrier 2) + band C (carrier 3)) |
| Case 5 | 1T + 0T + 1T | 1P + 0P + 0P, 0P + 0P + 1P, 1P + 0P + 1P |
| | | (option 2) |
| Case 3 | 2T + 0T + 0T | 2P + 0P + 0P, 1P + 0P + 0P |

Example 2: As shown in Table 4, Table 4 may represent switching between Case 2, Case 3, and Case 4, for example, switching from Case 2 to Case 3 or switching from Case 3 to Case 4. A quantity of bands including Tx before/after Tx switching is equal to 1, and indexes are different, and another switching case is similar. A quantity of Txs on one band is 2.

TABLE 4

| | Quantity of | Quantity of antenna ports for uplink |
|---|---|---|
| | switching | transmission (band A (carrier 1) + band B |
| | channels | (carrier 2) + band C (carrier 3)) |
| Case 2 | 0T + 2T + 0T | 0P + 2P + 0P, 0P + 1P + 0P |
| Case 3 | 2T + 0T + 0T | 2P + 0P + 0P, 1P + 0P + 0P |
| Case 4 | 0T + 0T + 2T | 0P + 0P + 2P, 0P + 0P + 1P |

Example 3: As shown in Table 5, Table 5 may represent switching between Case 1, Case 5, and Case 6, for example, switching from Case 1 to Case 5 or switching from Case 5 to Case 6. A quantity of bands including Tx before/after Tx switching is equal to 2, and indexes are partially the same.

TABLE 5

| | Quantity of | Quantity of antenna ports for uplink |
|---|---|---|
| | switching | transmission (band A (carrier 1) + band B |
| | channels | (carrier 2) + band C (carrier 3)) |
| Case 1 | 1T + 1T + 0T | 1P + 0P + 0P, 0P + 1P + 0P, 1P + 1P + 0P |
| | | (option 2) |
| Case 5 | 1T + 0T + 1T | 1P + 0P + 0P, 0P + 0P + 1P, 1P + 0P + 1P |
| | | (option 2) |
| Case 6 | 0T + 1T + 1T | 0P + 1P + 0P, 0P + 0P + 1P, 0P + 1P + 1P |
| | | (option 2) |

Example 4: As shown in Table 6, for example, in switching from Case 1 to Case 4, a quantity of bands including Tx before Tx switching is equal to 2, a quantity of bands including Tx before Tx switching is equal to 1, and indexes are different. A quantity of Txs on the first two bands is 1, and the third band supports two Txs. Table 6 may represent switching from Case 1 to Case 4 or switching from Case 4 to Case 1.

TABLE 6

| | Quantity of | Quantity of antenna ports for uplink |
|---|---|---|
| | switching | transmission (band A (carrier 1) + band B |
| | channels | (carrier 2) + band C (carrier 3)) |
| Case 1 | 1T + 1T + 0T | 1P + 0P + 0P, 0P + 1P + 0P, 1P + 1P + 0P |
| | | (option 2) |
| Case 4 | 0T + 0T + 2T | 0P + 0P + 2P, 0P + 0P + 1P |

Example 5: As shown in Table 7, for example, in switching from Case 1 to Case 6, a quantity of bands including Tx before/after Tx switching is equal to 2, and indexes are different. A quantity of Txs on one band is 1. Table 7 may represent switching from Case 1 to Case 6 or switching from Case 6 to Case 1.

TABLE 7

| | Quantity of | Quantity of antenna ports for uplink |
|---|---|---|
| | switching | transmission (band A (carrier 1) + band B |
| | channels | (carrier 2) + band C (carrier 3)) |
| Case 1 | 1T + 1T + 0T | 1P + 0P + 0P, 0P + 1P + 0P, 1P + 1P + 0P |
| | | (option 2) |
| Case 6 | 0T + 1T + 1T | 0P + 1P + 0P, 0P + 0P + 1P, 0P + 1P + 1P |
| | | (option 2) |

The terminal determines a switching case (for example, switching between which two cases), to determine the target parameter used for switching.

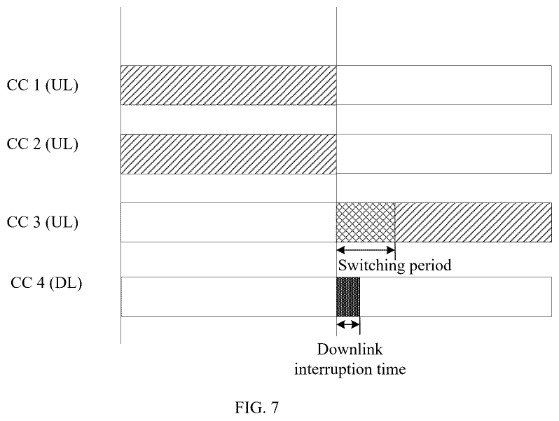

For example, if the terminal reports/the network side device configures that a switching period of Case 4 in the foregoing example is 210 us, and a physical unit associated with the switching period is configured as the band C, the downlink interruption time (DL interruption time) is the first slot from the switching period. As shown in FIG. 7, a CC 3 is a carrier associated with a switching period, and a CC 4 is a carrier configured with downlink interruption.

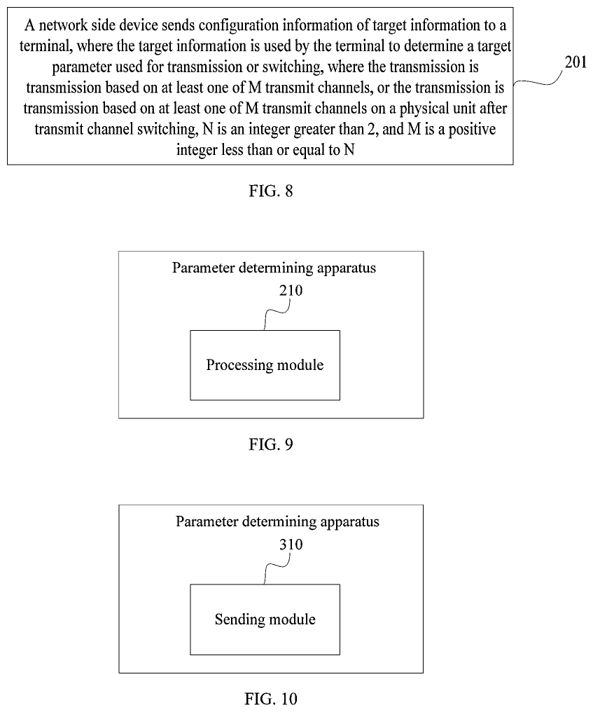

FIG. 8 is a second schematic flowchart of a parameter determining method according to an embodiment of this application. As shown in FIG. 8, the method provided in this embodiment includes the following steps:
Step 201: A network side device sends configuration information of target information to a terminal, where the target information is used by the terminal to determine a target parameter used for transmission or switching, where the transmission is transmission based on at least one of M transmit channels, or the transmission is transmission based on at least one of M transmit channels on a physical unit after transmit channel switching, N is an integer greater than 2, M is a positive integer less than or equal to N, and the target information includes at least one of the following:
a physical unit on which at least one of the M transmit channels is located;
a transmit channel included or used by at least one of the N physical units;
a quantity of at least one item of transmit channels, antenna ports, or MIMO layers supported by at least one of the N physical units;
a physical unit supported by at least one of the M transmit channels; and
a release of the terminal and/or the network side device.

In some embodiments, the method further includes:
receiving, by the network side device, capability information reported by the terminal;
determining, by the network side device, a correspondence between the target information and a parameter based on the capability information reported by the terminal; and
sending, by the network side device, the correspondence between the target information and the parameter to the terminal.

In some embodiments, a quantity of physical units on which at least one of the M transmit channels is located meets at least one of the following:
a quantity of physical units including transmit channels before transmit channel switching is equal to, greater than, or less than a first threshold;
a quantity of physical units using transmit channels before transmit channel switching is equal to, greater than, or less than a second threshold;
a quantity of physical units including transmit channels after transmit channel switching is equal to, greater than, or less than a third threshold;
a quantity of physical units using transmit channels after transmit channel switching is equal to, greater than, or less than a fourth threshold;
a total quantity of physical units including transmit channels before and after transmit channel switching is equal to, greater than, or less than a fifth threshold;
a total quantity of physical units using transmit channels before and after transmit channel switching is equal to, greater than, or less than a sixth threshold;
a sum of a quantity of physical units including transmit channels before transmit channel switching and a quantity of physical units including transmit channels after a transmission change, a scheduling change, or switching is equal to, greater than, or less than a seventh threshold; and
a sum of a quantity of physical units using transmit channels before transmit channel switching and a quantity of physical units using transmit channels after transmit channel switching is equal to, greater than, or less than an eighth threshold, where
the physical unit including a transmit channel represents a physical unit that has a transmit channel, and the physical unit using a transmit channel represents a physical unit that has a transmit channel and uses the transmit channel to send data.

In some embodiments, an index of the physical unit on which the at least one of the M transmit channels is located meets at least one of the following:
indexes of physical units including transmit channels before and after transmit channel switching are totally the same;
indexes of physical units using transmit channels before and after transmit channel switching are totally the same;
indexes of physical units including transmit channels before and after transmit channel switching are partially the same;
indexes of physical units using transmit channels before and after transmit channel switching are partially the same;
indexes of physical units including transmit channels before and after transmit channel switching are totally different; and
indexes of physical units using transmit channels before and after transmit channel switching are totally different, where
the physical unit including a transmit channel represents a physical unit that has a transmit channel, and the physical unit using a transmit channel represents a physical unit that has a transmit channel and uses the transmit channel to send data.

In some embodiments, a quantity of transmit channels included or used by at least one of the N physical units meets at least one of the following:
a quantity of transmit channels included in a physical unit before transmit channel switching is equal to, greater than, or less than a ninth threshold;
a quantity of transmit channels used by a physical unit before transmit channel switching is equal to, greater than, or less than a tenth threshold;
a quantity of transmit channels included in a physical unit after transmit channel switching is equal to, greater than, or less than an eleventh threshold;
a quantity of transmit channels used by a physical unit after transmit channel switching is equal to, greater than, or less than a twelfth threshold;
a total quantity of transmit channels included in a physical unit before and after transmit channel switching is equal to, greater than, or less than a thirteenth threshold; and
a total quantity of transmit channels used by a physical unit before and after transmit channel switching is equal to, greater than, or less than a fourteenth threshold, where
the physical unit including a transmit channel represents a physical unit that has a transmit channel, and the physical unit using a transmit channel represents a physical unit that has a transmit channel and uses the transmit channel to send data.

In some embodiments, a quantity of physical units supported by at least one of the M transmit channels meets:
a maximum quantity of physical units supported by the at least one transmit channel is a fifteenth threshold.

In some embodiments, an index of the physical unit supported by the at least one of the M transmit channels meets:
the index of the physical unit supported by the at least one transmit channel belongs to a first index set.

In some embodiments, the quantity of at least one item of transmit channels, antenna ports, or MIMO layers supported by the at least one of the N physical units meets:
a maximum quantity of transmit channels supported by the at least one physical unit is a sixteenth threshold;
a maximum quantity of antenna ports supported by the at least one physical unit is a seventeenth threshold; and
a maximum quantity of MIMO layers supported by the at least one physical unit is an eighteenth threshold.

In some embodiments, the parameter includes:
at least one physical unit for transmission or switching;
switching period information required for transmit channel switching, where the switching period information includes at least one of the following: duration, a start time, and an end time;
downlink interruption time information required for transmit channel switching, where the downlink interruption time information includes at least one of the following: duration, a start time, and an end time;
a transmission or switching type;
a capability of transmit channel parallel switching and/or serial switching;
a maximum quantity of transmission or switching periods in a preset time range;
a physical unit with downlink interruption in a process of transmit channel switching; and
a physical unit associated with switching period information.

In some embodiments, the parameter is determined based on the capability information of the terminal and/or is configured by the network side device.

In some embodiments, the parameter is reported and/or configured based on each target unit, and the target unit includes at least one of the following: a physical unit pair, a physical unit list, and a physical unit combination.

In some embodiments, the downlink interruption time information is related to at least one of the following:
a physical unit with downlink interruption, switching period information, or a physical unit associated with switching period information.

In some embodiments, at least one target unit corresponding to the terminal has a same physical unit with downlink interruption; or
each of at least one target unit corresponding to the terminal respectively has a physical unit with downlink interruption.

In some embodiments, at least one target unit corresponding to the terminal has same switching period information; or
each of at least one target unit corresponding to the terminal respectively has switching period information.

In some embodiments, at least one target unit corresponding to the terminal has a same physical unit associated with switching period information; or
each of at least one target unit corresponding to the terminal respectively has a physical unit associated with switching period information.

In some embodiments, the transmission or switching type includes a type of whether simultaneous transmission and/or switching are/is supported between different physical units.

In some embodiments, the physical unit includes at least one of the following: a carrier, a bandwidth part BWP, a band, or a resource pool.

A specific implementation process and a technical effect of the method in this embodiment are the same as those in the method embodiment on the terminal side. For details, refer to the detailed descriptions of the method embodiment on the terminal side. Details are not described herein again.

The parameter determining method provided in the embodiments of this application may be performed by a parameter determining apparatus. In the embodiments of this application, an example in which the parameter determining apparatus performs the parameter determining method is used to describe the parameter determining apparatus provided in the embodiments of this application.

FIG. 9 is a first schematic structural diagram of a parameter determining apparatus according to an embodiment of this application. As shown in FIG. 9, the parameter determining apparatus provided in this embodiment is applied to a terminal, a configuration resource of the terminal includes N physical units, and the apparatus includes:
a processing module 210, configured to: in a case that transmission is performed on at least one of the N physical units, determine, based on target information, a target parameter used for transmission or switching, where the transmission is transmission based on at least one of M transmit channels, or the transmission is transmission based on at least one of M transmit channels on a physical unit after transmit channel switching, N is an integer greater than 2, M is a positive integer less than or equal to N, and the target information includes at least one of the following:
a physical unit on which at least one of the M transmit channels is located;
a transmit channel included or used by at least one of the N physical units;
a quantity of at least one item of transmit channels, antenna ports, or MIMO layers supported by at least one of the N physical units;
a physical unit supported by at least one of the M transmit channels; and
a release of the terminal and/or a network side device, where N is greater than 2, and M is less than N.

In some embodiments, the processing module 210 is configured to:
determine the target parameter based on a correspondence between the target information and a parameter and based on the target information corresponding to the terminal.

In some embodiments, the correspondence is obtained in at least one of the following manners: being determined based on capability information of the terminal, being configured by the network side device, or being specified in a protocol; and/or
the target information is determined based on the capability information of the terminal and/or is configured by the network side device; and/or a value of the parameter is determined based on the capability information of the terminal and/or is configured by the network side device.

In some embodiments, a quantity of physical units on which at least one of the M transmit channels is located meets at least one of the following:
a quantity of physical units including transmit channels before transmit channel switching is equal to, greater than, or less than a first threshold;
a quantity of physical units using transmit channels before transmit channel switching is equal to, greater than, or less than a second threshold;
a quantity of physical units including transmit channels after transmit channel switching is equal to, greater than, or less than a third threshold;
a quantity of physical units using transmit channels after transmit channel switching is equal to, greater than, or less than a fourth threshold;
a total quantity of physical units including transmit channels before and after transmit channel switching is equal to, greater than, or less than a fifth threshold;
a total quantity of physical units using transmit channels before and after transmit channel switching is equal to, greater than, or less than a sixth threshold;
a sum of a quantity of physical units including transmit channels before transmit channel switching and a quantity of physical units including transmit channels after transmit channel switching is equal to, greater than, or less than a seventh threshold; and
a sum of a quantity of physical units using transmit channels before transmit channel switching and a quantity of physical units using transmit channels after transmit channel switching is equal to, greater than, or less than an eighth threshold, where
the physical unit including a transmit channel represents a physical unit that has a transmit channel, and the physical unit using a transmit channel represents a physical unit that has a transmit channel and uses the transmit channel to send data.

In some embodiments, an index of the physical unit on which the at least one of the M transmit channels is located meets at least one of the following:
indexes of physical units including transmit channels before and after transmit channel switching are totally the same;
indexes of physical units using transmit channels before and after transmit channel switching are totally the same;
at least one of indexes of physical units including transmits channel before and after transmit channel switching is the same;
at least one of indexes of physical units using transmit channels before and after transmit channel switching is the same;
indexes of physical units including transmit channels before and after transmit channel switching are totally different; and
indexes of physical units using transmit channels before and after transmit channel switching are totally different, where
the physical unit including a transmit channel represents a physical unit that has a transmit channel, and the physical unit using a transmit channel represents a physical unit that has a transmit channel and uses the transmit channel to send data.

In some embodiments, a quantity of transmit channels included or used by at least one of the N physical units meets at least one of the following:
a quantity of transmit channels included in a physical unit before transmit channel switching is equal to, greater than, or less than a ninth threshold;
a quantity of transmit channels used by a physical unit before transmit channel switching is equal to, greater than, or less than a tenth threshold;
a quantity of transmit channels included in a physical unit after transmit channel switching is equal to, greater than, or less than an eleventh threshold;
a quantity of transmit channels used by a physical unit after transmit channel switching is equal to, greater than, or less than a twelfth threshold;
a total quantity of transmit channels included in a physical unit before and after transmit channel switching is equal to, greater than, or less than a thirteenth threshold; and
a total quantity of transmit channels used by a physical unit before and after transmit channel switching is equal to, greater than, or less than a fourteenth threshold, where
the physical unit including a transmit channel represents a physical unit that has a transmit channel, and the physical unit using a transmit channel represents a physical unit that has a transmit channel and uses the transmit channel to send data.

In some embodiments, a quantity of physical units supported by at least one of the M transmit channels meets:
a maximum quantity of physical units supported by the at least one transmit channel is a fifteenth threshold.

In some embodiments, an index of the physical unit supported by the at least one of the M transmit channels meets:
the index of the physical unit supported by the at least one transmit channel belongs to a first index set.

In some embodiments, the quantity of at least one item of transmit channels, antenna ports, or MIMO layers supported by the at least one of the N physical units meets at least one of the following:
a maximum quantity of transmit channels supported by the at least one physical unit is a sixteenth threshold;
a maximum quantity of antenna ports supported by the at least one physical unit is a seventeenth threshold; and
a maximum quantity of MIMO layers supported by the at least one physical unit is an eighteenth threshold.

In some embodiments, in a case that the correspondence is configured by the network side device, the correspondence is configured based on capability information reported by the terminal.

In some embodiments, the parameter includes:
at least one physical unit for transmission or switching;
switching period information required for transmit channel switching, where the switching period information includes at least one of the following: duration, a start time, and an end time;
downlink interruption time information required for transmit channel switching, where the downlink interruption time information includes at least one of the following: duration, a start time, and an end time;
a transmission or switching type;
a capability of transmit channel parallel switching and/or serial switching;
a maximum quantity of transmission or switching periods in a preset time range;
a physical unit with downlink interruption in a process of transmit channel switching; and
a physical unit associated with switching period information.

In some embodiments, the parameter is reported and/or configured based on each target unit, and the target unit includes at least one of the following: a physical unit pair, a physical unit list, and a physical unit combination.

In some embodiments, the downlink interruption time information is related to at least one of the following:
a physical unit with downlink interruption, switching period information, or a physical unit associated with switching period information.

In some embodiments, at least one target unit corresponding to the terminal has a same physical unit with downlink interruption; or
each of at least one target unit corresponding to the terminal respectively has a physical unit with downlink interruption.

In some embodiments, at least one target unit corresponding to the terminal has same switching period information; or
each of at least one target unit corresponding to the terminal respectively has switching period information.

In some embodiments, at least one target unit corresponding to the terminal has a same physical unit associated with switching period information; or
each of at least one target unit corresponding to the terminal respectively has a physical unit associated with switching period information.

In some embodiments, the transmission or switching type includes a type of whether simultaneous transmission and/or switching are/is supported between different physical units.

In some embodiments, the physical unit includes at least one of the following: a carrier, a bandwidth part BWP, a band, or a resource pool.

The apparatus in this embodiment may be configured to perform the method in any one of the foregoing method embodiments on the terminal side. A specific implementation process and a technical effect are the same as those in the method embodiment on the terminal side. For details, refer to the detailed descriptions of the method embodiment on the terminal side. Details are not described herein again.

FIG. 10 is a second schematic structural diagram of a parameter determining apparatus according to an embodiment of this application. As shown in FIG. 10, the parameter determining apparatus provided in this embodiment includes:
a sending module 310, configured to send configuration information of target information to a terminal, where the target information is used by the terminal to determine a target parameter used for transmission or switching, where the transmission is transmission based on at least one of M transmit channels, or the transmission is transmission based on at least one of M transmit channels on a physical unit after transmit channel switching, N is an integer greater than 2, M is a positive integer less than or equal to N, and the target information includes at least one of the following:
a physical unit on which at least one of the M transmit channels is located;
a transmit channel included or used by at least one of the N physical units;
a quantity of at least one item of transmit channels, antenna ports, or MIMO layers supported by at least one of the N physical units;
a physical unit supported by at least one of the M transmit channels; and
a release of the terminal and/or a network side device.

In some embodiments, the apparatus further includes:
a receiving module, configured to receive capability information reported by the terminal; and
a processing module, configured to determine a correspondence between the target information and a parameter based on the capability information reported by the terminal, where
the sending module 310 is further configured to send the correspondence between the target information and the parameter to the terminal.

In some embodiments, a quantity of physical units on which at least one of the M transmit channels is located meets at least one of the following:
a quantity of physical units including transmit channels before transmit channel switching is equal to, greater than, or less than a first threshold;
a quantity of physical units using transmit channels before transmit channel switching is equal to, greater than, or less than a second threshold;
a quantity of physical units including transmit channels after transmit channel switching is equal to, greater than, or less than a third threshold;
a quantity of physical units using transmit channels after transmit channel switching is equal to, greater than, or less than a fourth threshold;
a total quantity of physical units including transmit channels before and after transmit channel switching is equal to, greater than, or less than a fifth threshold;
a total quantity of physical units using transmit channels before and after transmit channel switching is equal to, greater than, or less than a sixth threshold;
a sum of a quantity of physical units including transmit channels before transmit channel switching and a quantity of physical units including transmit channels after a transmission change, a scheduling change, or switching is equal to, greater than, or less than a seventh threshold; and
a sum of a quantity of physical units using transmit channels before transmit channel switching and a quantity of physical units using transmit channels after transmit channel switching is equal to, greater than, or less than an eighth threshold, where
the physical unit including a transmit channel represents a physical unit that has a transmit channel, and the physical unit using a transmit channel represents a physical unit that has a transmit channel and uses the transmit channel to send data.

In some embodiments, an index of the physical unit on which the at least one of the M transmit channels is located meets at least one of the following:
indexes of physical units including transmit channels before and after transmit channel switching are totally the same;
indexes of physical units using transmit channels before and after transmit channel switching are totally the same;
at least one of indexes of physical units including transmits channel before and after transmit channel switching is the same;
at least one of indexes of physical units using transmit channels before and after transmit channel switching is the same;
indexes of physical units including transmit channels before and after transmit channel switching are totally different; and
indexes of physical units using transmit channels before and after transmit channel switching are totally different, where
the physical unit including a transmit channel represents a physical unit that has a transmit channel, and the physical unit using a transmit channel represents a physical unit that has a transmit channel and uses the transmit channel to send data.

In some embodiments, a quantity of transmit channels included or used by at least one of the N physical units meets at least one of the following:
a quantity of transmit channels included in a physical unit before transmit channel switching is equal to, greater than, or less than a ninth threshold;
a quantity of transmit channels used by a physical unit before transmit channel switching is equal to, greater than, or less than a tenth threshold;
a quantity of transmit channels included in a physical unit after transmit channel switching is equal to, greater than, or less than an eleventh threshold;
a quantity of transmit channels used by a physical unit after transmit channel switching is equal to, greater than, or less than a twelfth threshold;
a total quantity of transmit channels included in a physical unit before and after transmit channel switching is equal to, greater than, or less than a thirteenth threshold; and
a total quantity of transmit channels used by a physical unit before and after transmit channel switching is equal to, greater than, or less than a fourteenth threshold, where
the physical unit including a transmit channel represents a physical unit that has a transmit channel, and the physical unit using a transmit channel represents a physical unit that has a transmit channel and uses the transmit channel to send data.

In some embodiments, a quantity of physical units supported by at least one of the M transmit channels meets:
a maximum quantity of physical units supported by the at least one transmit channel is a fifteenth threshold.

In some embodiments, an index of the physical unit supported by the at least one of the M transmit channels meets:
the index of the physical unit supported by the at least one transmit channel belongs to a first index set.

In some embodiments, the quantity of at least one item of transmit channels, antenna ports, or MIMO layers supported by the at least one of the N physical units meets:
a maximum quantity of transmit channels supported by the at least one physical unit is a sixteenth threshold;
a maximum quantity of antenna ports supported by the at least one physical unit is a seventeenth threshold; and
a maximum quantity of MIMO layers supported by the at least one physical unit is an eighteenth threshold.

In some embodiments, the parameter includes:
at least one physical unit for transmission or switching;
switching period information required for transmit channel switching, where the switching period information includes at least one of the following: duration, a start time, and an end time;
downlink interruption time information required for transmit channel switching, where the downlink interruption time information includes at least one of the following: duration, a start time, and an end time;
a transmission or switching type;
a capability of transmit channel parallel switching and/or serial switching;
a maximum quantity of transmission or switching periods in a preset time range;
a physical unit with downlink interruption in a process of transmit channel switching; and
a physical unit associated with switching period information.

In some embodiments, the parameter is determined based on the capability information of the terminal and/or is configured by the network side device.

In some embodiments, the parameter is reported and/or configured based on each target unit, and the target unit includes at least one of the following: a physical unit pair, a physical unit list, and a physical unit combination.

In some embodiments, the downlink interruption time information is related to at least one of the following:
a physical unit with downlink interruption, switching period information, or a physical unit associated with switching period information.

In some embodiments, at least one target unit corresponding to the terminal has a same physical unit with downlink interruption; or
each of at least one target unit corresponding to the terminal respectively has a physical unit with downlink interruption.

In some embodiments, at least one target unit corresponding to the terminal has same switching period information; or
each of at least one target unit corresponding to the terminal respectively has switching period information.

In some embodiments, at least one target unit corresponding to the terminal has a same physical unit associated with switching period information; or
each of at least one target unit corresponding to the terminal respectively has a physical unit associated with switching period information.

In some embodiments, the transmission or switching type includes a type of whether simultaneous transmission and/or switching are/is supported between different physical units.

In some embodiments, the physical unit includes at least one of the following: a carrier, a bandwidth part BWP, a band, or a resource pool.

The apparatus in this embodiment may be configured to perform the method in any one of the foregoing method embodiments on the network side. A specific implementation process and a technical effect are the same as those in the method embodiment on the network side. For details, refer to the detailed descriptions of the method embodiment on the network side. Details are not described herein again.

The parameter determining apparatus in this embodiment of this application may be an electronic device, for example, an electronic device with an operating system, or may be a component in the electronic device, for example, an integrated circuit or a chip. The electronic device may be a terminal, or another device other than the terminal. For example, the terminal may include but is not limited to the foregoing listed types of the terminal 11, and the another device may be a server, a Network Attached Storage (NAS), or the like. This is not specifically limited in this embodiment of this application.

The parameter determining apparatus provided in this embodiment of this application can implement the processes implemented in the method embodiments of FIG. 6 to FIG. 8, and achieve a same technical effect. To avoid repetition, details are not described herein again.

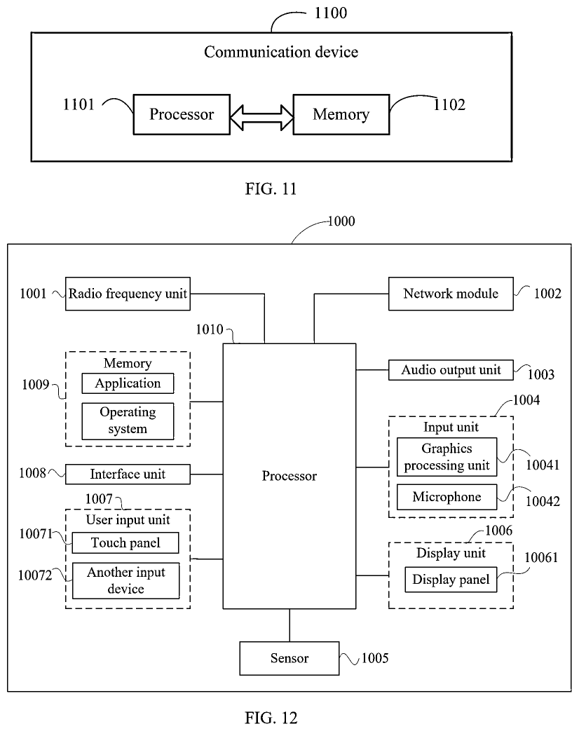

In some embodiments, as shown in FIG. 11, an embodiment of this application further provides a communication device 1100, including a processor 1101 and a memory 1102. The memory 1102 stores a program or an instruction that can be run on the processor 1101. For example, when the communication device 1100 is a terminal, the program or the instruction is executed by the processor 1101 to implement the steps of the foregoing parameter determining method embodiment, and a same technical effect can be achieved. When the communication device 1100 is a network side device, the program or the instruction is executed by the processor 1101 to implement the steps of the foregoing parameter determining method embodiment, and a same technical effect can be achieved. To avoid repetition, details are not described herein again.

An embodiment of this application further provides a terminal, including a processor and a communication interface. The processor is configured to: in a case that transmission is performed on at least one of N physical units, determine, by the terminal based on target information, a target parameter used for transmission or switching, where the transmission is transmission based on at least one of M transmit channels, or the transmission is transmission based on at least one of M transmit channels on a physical unit after transmit channel switching, N is an integer greater than 2, M is a positive integer less than or equal to N, and the target information includes at least one of the following: a physical unit on which at least one of the M transmit channels is located; a transmit channel included or used by at least one of the N physical units; a quantity of at least one item of transmit channels, antenna ports, or MIMO layers supported by at least one of the N physical units; a physical unit supported by at least one of the M transmit channels; and a release of the terminal and/or a network side device, where N is greater than 2, and M is less than N. The terminal embodiment corresponds to the method embodiment on the terminal side, each implementation process and implementation of the foregoing method embodiment can be applied to the terminal embodiment, and a same technical effect can be achieved. In some embodiments, FIG. 12 is a schematic structural diagram of hardware of a terminal according to an embodiment of this application.

A terminal 1000 includes but is not limited to components such as a radio frequency unit 1001, a network module 1002, an audio output unit 1003, an input unit 1004, a sensor 1005, a display unit 1006, a user input unit 1007, an interface unit 1008, a memory 1009, and a processor 1010.

A person skilled in the art can understand that the terminal 1000 may further include the power supply (for example, a battery) that supplies power to each component. The power supply may be logically connected to the processor 1010 by using a power supply management system, so as to manage functions such as charging, discharging, and power consumption by using the power supply management system. The terminal structure shown in FIG. 12 constitutes no limitation on the terminal, and the terminal may include more or fewer components than those shown in the figure, or combine some components, or have different component arrangements. Details are not described herein.

It should be understood that, in this embodiment of this application, the input unit 1004 may include a Graphics Processing Unit (GPU) 10041 and a microphone 10042, and the graphics processing unit 10041 processes image data of a still image or a video that is obtained by an image capturing apparatus (for example, a camera) in a video capturing mode or an image capturing mode. The display unit 1006 may include a display panel 10061. The display panel 10061 may be configured in a form such as a liquid crystal display or an organic light-emitting diode. The user input unit 1007 includes at least one of a touch panel 10071 and another input device 10072. The touch panel 10071 is also referred to as a touchscreen. The touch panel 10071 may include two parts: a touch detection apparatus and a touch controller. The another input device 10072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 1001 may transmit the downlink data to the processor 1010 for processing. In addition, the radio frequency unit 1001 may send uplink data to the network side device. Usually, the radio frequency unit 1001 includes but is not limited to an antenna, at least one amplifier, a transceiver, a coupler, a low noise amplifier, a duplexer, and the like.

The memory 1009 may be configured to store a software program or an instruction and various data. The memory 1009 may mainly include a first storage area for storing a program or an instruction and a second storage area for storing data. The first storage area or the instruction area may store an operating system, and an application or an instruction required by at least one function (for example, a sound playing function or an image playing function). In addition, the memory 1009 may be a volatile memory or a non-volatile memory, or the memory 1009 may include a volatile memory and a non-volatile memory. The memory 1009 may include a high-speed random access memory, and may further include a non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synch link DRAM (SLDRAM), and a Direct Rambus RAM (DRRAM). The memory 1009 in this embodiment of this application includes but is not limited to these memories and any memory of another proper type, for example, at least one disk storage device, a flash memory device, or another non-volatile solid-state storage device.

The processor 1010 may include one or more processing units. In some embodiments, an application processor and a modem processor are integrated into the processor 1010. The application processor mainly processes an operating system, a user interface, an application, an instruction, or the like. The modem processor mainly processes a wireless communication signal, for example, a baseband processor. It can be understood that, in some embodiments, the modem processor may not be integrated into the processor 1010.

The processor 1010 is configured to: in a case that transmission is performed on at least one of N physical units, determine, by the terminal based on target information, a target parameter used for transmission or switching, where the transmission is transmission based on at least one of M transmit channels, or the transmission is transmission based on at least one of M transmit channels on a physical unit after transmit channel switching, N is an integer greater than 2, M is a positive integer less than or equal to N, and the target information includes at least one of the following:
a physical unit on which at least one of the M transmit channels is located;
a transmit channel included or used by at least one of the N physical units;
a quantity of at least one item of transmit channels, antenna ports, or MIMO layers supported by at least one of the N physical units;
a physical unit supported by at least one of the M transmit channels; and
a release of the terminal and/or a network side device.

In some embodiments, the processor 1010 is configured to:
determine the target parameter based on a correspondence between the target information and a parameter and based on the target information corresponding to the terminal.

In some embodiments, the correspondence is obtained in at least one of the following manners: being determined based on capability information of the terminal, being configured by the network side device, or being specified in a protocol; and/or
the target information is determined based on the capability information of the terminal and/or is configured by the network side device; and/or a value of the parameter is determined based on the capability information of the terminal and/or is configured by the network side device.

In some embodiments, a quantity of physical units on which at least one of the M transmit channels is located meets at least one of the following:
a quantity of physical units including transmit channels before transmit channel switching is equal to, greater than, or less than a first threshold;
a quantity of physical units using transmit channels before transmit channel switching is equal to, greater than, or less than a second threshold;
a quantity of physical units including transmit channels after transmit channel switching is equal to, greater than, or less than a third threshold;
a quantity of physical units using transmit channels after transmit channel switching is equal to, greater than, or less than a fourth threshold;
a total quantity of physical units including transmit channels before and after transmit channel switching is equal to, greater than, or less than a fifth threshold;
a total quantity of physical units using transmit channels before and after transmit channel switching is equal to, greater than, or less than a sixth threshold;
a sum of a quantity of physical units including transmit channels before transmit channel switching and a quantity of physical units including transmit channels after transmit channel switching is equal to, greater than, or less than a seventh threshold; and
a sum of a quantity of physical units using transmit channels before transmit channel switching and a quantity of physical units using transmit channels after transmit channel switching is equal to, greater than, or less than an eighth threshold, where
the physical unit including a transmit channel represents a physical unit that has a transmit channel, and the physical unit using a transmit channel represents a physical unit that has a transmit channel and uses the transmit channel to send data.

In some embodiments, an index of the physical unit on which the at least one of the M transmit channels is located meets at least one of the following:
indexes of physical units including transmit channels before and after transmit channel switching are totally the same;
indexes of physical units using transmit channels before and after transmit channel switching are totally the same;
at least one of indexes of physical units including transmits channel before and after transmit channel switching is the same;
at least one of indexes of physical units using transmit channels before and after transmit channel switching is the same;
indexes of physical units including transmit channels before and after transmit channel switching are totally different; and
indexes of physical units using transmit channels before and after transmit channel switching are totally different, where
the physical unit including a transmit channel represents a physical unit that has a transmit channel, and the physical unit using a transmit channel represents a physical unit that has a transmit channel and uses the transmit channel to send data.

In some embodiments, a quantity of transmit channels included or used by at least one of the N physical units meets at least one of the following:
a quantity of transmit channels included in a physical unit before transmit channel switching is equal to, greater than, or less than a ninth threshold;
a quantity of transmit channels used by a physical unit before transmit channel switching is equal to, greater than, or less than a tenth threshold;
a quantity of transmit channels included in a physical unit after transmit channel switching is equal to, greater than, or less than an eleventh threshold;
a quantity of transmit channels used by a physical unit after transmit channel switching is equal to, greater than, or less than a twelfth threshold;
a total quantity of transmit channels included in a physical unit before and after transmit channel switching is equal to, greater than, or less than a thirteenth threshold; and
a total quantity of transmit channels used by a physical unit before and after transmit channel switching is equal to, greater than, or less than a fourteenth threshold, where
the physical unit including a transmit channel represents a physical unit that has a transmit channel, and the physical unit using a transmit channel represents a physical unit that has a transmit channel and uses the transmit channel to send data.

In some embodiments, a quantity of physical units supported by at least one of the M transmit channels meets:
a maximum quantity of physical units supported by the at least one transmit channel is a fifteenth threshold.

In some embodiments, an index of the physical unit supported by the at least one of the M transmit channels meets:
the index of the physical unit supported by the at least one transmit channel belongs to a first index set.

In some embodiments, the quantity of at least one item of transmit channels, antenna ports, or MIMO layers supported by the at least one of the N physical units meets at least one of the following:
a maximum quantity of transmit channels supported by the at least one physical unit is a sixteenth threshold;
a maximum quantity of antenna ports supported by the at least one physical unit is a seventeenth threshold; and
a maximum quantity of MIMO layers supported by the at least one physical unit is an eighteenth threshold.

In some embodiments, in a case that the correspondence is configured by the network side device, the correspondence is configured based on capability information reported by the terminal.

In some embodiments, the parameter includes:
at least one physical unit for transmission or switching;
switching period information required for transmit channel switching, where the switching period information includes at least one of the following: duration, a start time, and an end time;
downlink interruption time information required for transmit channel switching, where the downlink interruption time information includes at least one of the following: duration, a start time, and an end time;
a transmission or switching type;
a capability of transmit channel parallel switching and/or serial switching;
a maximum quantity of transmission or switching periods in a preset time range;
a physical unit with downlink interruption in a process of transmit channel switching; and
a physical unit associated with switching period information.

In some embodiments, the parameter is reported and/or configured based on each target unit, and the target unit includes at least one of the following: a physical unit pair, a physical unit list, and a physical unit combination.

In some embodiments, the downlink interruption time information is related to at least one of the following:
a physical unit with downlink interruption, switching period information, or a physical unit associated with switching period information.

In some embodiments, at least one target unit corresponding to the terminal has a same physical unit with downlink interruption; or
each of at least one target unit corresponding to the terminal respectively has a physical unit with downlink interruption.

In some embodiments, at least one target unit corresponding to the terminal has same switching period information; or
each of at least one target unit corresponding to the terminal respectively has switching period information.

In some embodiments, at least one target unit corresponding to the terminal has a same physical unit associated with switching period information; or
each of at least one target unit corresponding to the terminal respectively has a physical unit associated with switching period information.

In some embodiments, the transmission or switching type includes a type of whether simultaneous transmission and/or switching are/is supported between different physical units.

In some embodiments, the physical unit includes at least one of the following: a carrier, a bandwidth part BWP, a band, or a resource pool.

An embodiment of this application further provides a network side device, including a processor and a communication interface. The communication interface is configured to send configuration information of target information to a terminal, where the target information is used by the terminal to determine a target parameter used for transmission or switching, where the transmission is transmission based on at least one of M transmit channels, or the transmission is transmission based on at least one of M transmit channels on a physical unit after transmit channel switching, N is an integer greater than 2, M is a positive integer less than or equal to N, and the target information includes at least one of the following: a physical unit on which at least one of the M transmit channels is located; a transmit channel included or used by at least one of the N physical units; a quantity of at least one item of transmit channels, antenna ports, or MIMO layers supported by at least one of the N physical units; a physical unit supported by at least one of the M transmit channels; and a release of the terminal and/or a network side device. This network side device embodiment corresponds to the foregoing method embodiment of the network side device, each implementation process and implementation of the foregoing method embodiment can be applied to this network side device embodiment, and a same technical effect can be achieved.

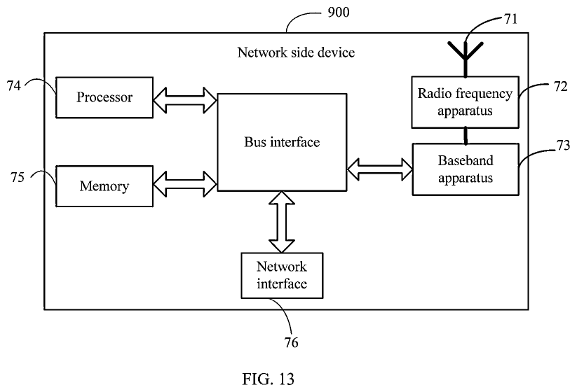

For example, an embodiment of this application further provides a network side device. As shown in FIG. 13, the network side device 900 includes an antenna 71, a radio frequency apparatus 72, a baseband apparatus 73, a processor 74, and a memory 75. The antenna 71 is connected to the radio frequency apparatus 72. In an uplink direction, the radio frequency apparatus 72 receives information by using the antenna 71, and sends the received information to the baseband apparatus 73 for processing. In a downlink direction, the baseband apparatus 73 processes information that needs to be sent, and sends processed information to the radio frequency apparatus 72. The radio frequency apparatus 72 processes the received information, and sends processed information by using the antenna 71.

The processor 74 and/or memory 75 may be located in the baseband apparatus 73. The method performed by the network side device in the foregoing embodiment may be implemented in the baseband apparatus 73. The baseband apparatus 73 includes a baseband processor 74 and a memory 75.

The baseband apparatus 73 may include, for example, at least one baseband board, where a plurality of chips are disposed on the baseband board. As shown in FIG. 13, one chip is, for example, the baseband processor 74, is connected to the memory 75 through a bus interface, to invoke a program in the memory 75 to perform the operations of the network device shown in the foregoing method embodiment.

The baseband apparatus 73 of the network side device may further include a network interface 76, configured to exchange information with the radio frequency apparatus 72. For example, the interface is a Common Public Radio Interface (CPRI).

For example, the network side device 700 in this embodiment of the present disclosure further includes an instruction or a program that is stored in the memory 75 and that can be run on the processor 74. The processor 74 invokes the instruction or the program in the memory 75 to perform the method performed by the modules shown in FIG. 10, and a same technical effect is achieved. To avoid repetition, details are not described herein again.

An embodiment of this application further provides a readable storage medium. The readable storage medium stores a program or an instruction, and the program or the instruction is executed by a processor to implement the processes of the foregoing parameter determining method embodiment, and a same technical effect can be achieved. To avoid repetition, details are not described herein again.

The processor is a processor in the terminal in the foregoing embodiment. The readable storage medium includes a computer readable storage medium, such as a computer read-only memory ROM, a random access memory RAM, a magnetic disk, or an optical disc.

An embodiment of this application further provides a chip. The chip includes a processor and a communication interface, the communication interface is coupled to the processor, and the processor is configured to run a program or an instruction to implement the processes of the foregoing parameter determining method embodiment, and a same technical effect can be achieved. To avoid repetition, details are not described herein again.

It should be understood that the chip mentioned in this embodiment of this application may also be referred to as a system-level chip, a system chip, a chip system, or an on-chip system chip.

An embodiment of this application further provides a computer program/program product. The computer program/program product is stored in a storage medium, and the program/program product is executed by at least one processor to implement the processes of the foregoing parameter determining method embodiment, and a same technical effect can be achieved. To avoid repetition, details are not described herein again.

An embodiment of this application further provides a communication system, including a terminal and a network side device. The terminal may be configured to perform the steps of the foregoing parameter determining method, and the network side device may be configured to perform the steps of the foregoing parameter determining method.

It should be noted that, in this specification, the terms “include”, “comprise”, or their any other variant are intended to cover a non-exclusive inclusion, so that a process, a method, an article, or an apparatus that includes a list of elements not only includes those elements but also includes other elements which are not expressly listed, or further includes elements inherent to such process, method, article, or apparatus. An element preceded by “includes a . . . ” does not, without more constraints, preclude the presence of additional identical elements in the process, method, article, or apparatus that includes the element. In addition, it should be noted that the scope of the method and the apparatus in the embodiments of this application is not limited to performing functions in an illustrated or discussed sequence, and may further include performing functions in a basically simultaneous manner or in a reverse sequence according to the functions concerned. For example, the described method may be performed in an order different from that described, and the steps may be added, omitted, or combined. In addition, features described with reference to some examples may be combined in other examples.

Based on the foregoing descriptions of the embodiments, a person skilled in the art may clearly understand that the method in the foregoing embodiment may be implemented by software in addition to a necessary universal hardware platform or by hardware only. In most circumstances, the former is an example implementation manner. Based on such an understanding, the technical solutions of this application essentially or the part contributing to the prior art may be implemented in a form of a computer software product. The computer software product is stored in a storage medium (for example, a ROM/RAM, a floppy disk, or an optical disc), and includes several instructions for instructing a terminal (which may be a mobile phone, a computer, a server, an air conditioner, a network device, or the like) to perform the methods described in the embodiments of this application.

The embodiments of this application are described above with reference to the accompanying drawings, but this application is not limited to the above specific implementations, and the above specific implementations are merely illustrative but not restrictive. Under the enlightenment of this application, a person of ordinary skill in the art can make many forms without departing from the purpose of this application and the protection scope of the claims, all of which fall within the protection of this application.

1. A parameter determining method, wherein a configuration resource of a terminal comprises N physical units, and the method comprises:
when the terminal performs transmission on at least one of the N physical units, determining, by the terminal based on target information, a target parameter used for transmission or switching, wherein the transmission is transmission based on at least one of M transmit channels, N is an integer greater than 2, M is a positive integer less than or equal to N, and the target information comprises at least one of the following:
a transmit channel comprised or used by at least one of the N physical units; or
a quantity of at least one item of transmit channels, antenna ports, or Multiple-Input Multiple-Output (MIMO) layers supported by at least one of the N physical units.

2. The method according to claim 1, wherein the determining, by the terminal based on the target information, the target parameter used for transmission or switching comprises:
determining, by the terminal, the target parameter based on a correspondence between the target information and a parameter and based on the target information corresponding to the terminal.

3. The method according to claim 2, wherein the correspondence is obtained in at least one of the following manners:
being configured by the network side device, or being specified in a protocol; or
the target information is determined based on the capability information of the terminal, or a value of the parameter is determined based on the capability information of the terminal.

4. The method according to claim 1, wherein a quantity of transmit channels comprised or used by at least one of the N physical units meets at least one of the following:
a quantity of transmit channels comprised in a physical unit before transmit channel switching is equal to, greater than, or less than a ninth threshold;
a quantity of transmit channels used by a physical unit before transmit channel switching is equal to, greater than, or less than a tenth threshold;
a quantity of transmit channels comprised in a physical unit after transmit channel switching is equal to, greater than, or less than an eleventh threshold;
a quantity of transmit channels used by a physical unit after transmit channel switching is equal to, greater than, or less than a twelfth threshold;
a total quantity of transmit channels comprised in a physical unit before and after transmit channel switching is equal to, greater than, or less than a thirteenth threshold; or
a total quantity of transmit channels used by a physical unit before and after transmit channel switching is equal to, greater than, or less than a fourteenth threshold, wherein
the physical unit comprising a transmit channel represents a physical unit that has a transmit channel, and the physical unit using a transmit channel represents a physical unit that has a transmit channel and uses the transmit channel to send data.

5. The method according to claim 1, wherein the quantity of at least one item of transmit channels, antenna ports, or MIMO layers supported by the at least one of the N physical units meets at least one of the following:
a maximum quantity of transmit channels supported by the at least one physical unit is a sixteenth threshold;
a maximum quantity of antenna ports supported by the at least one physical unit is a seventeenth threshold; or
a maximum quantity of MIMO layers supported by the at least one physical unit is an eighteenth threshold.

6. The method according to claim 2, wherein when the correspondence is configured by the network side device, the correspondence is configured based on capability information reported by the terminal.

7. The method according to claim 1, wherein the parameter comprises:
switching period information required for transmit channel switching, wherein the switching period information comprises at least one of the following: duration, a start time, or an end time.

8. The method according to claim 7, wherein the parameter is reported or configured based on each target unit, and the target unit comprises a physical unit pair.

9. The method according to claim 6, wherein
the transmission or switching type comprises a type of whether simultaneous transmission or switching is supported between different physical units.

10. The method according to claim 1, wherein
the physical unit comprises at least one of the following: a carrier, a bandwidth part BWP, a band, or a resource pool.

11. The method according to claim 1, wherein the target information further comprises at least one of the following:
a physical unit on which at least one of the M transmit channels is located;
a physical unit supported by at least one of the M transmit channels; or
a release of the terminal or a network side device.

12. The method according to claim 11, wherein a quantity of physical units supported by at least one of the M transmit channels meets:
a maximum quantity of physical units supported by the at least one transmit channel is a fifteenth threshold.

13. The method according to claim 11, wherein an index of the physical unit supported by the at least one of the M transmit channels meets:
the index of the physical unit supported by the at least one transmit channel belongs to a first index set.

14. A parameter determining method, comprising:
sending, by a network side device, configuration information of target information to a terminal, wherein the target information is used by the terminal to determine a target parameter used for transmission or switching, wherein the transmission is transmission based on at least one of M transmit channels, N is an integer greater than 2, M is a positive integer less than or equal to N, and the target information comprises at least one of the following:
a transmit channel comprised or used by at least one of the N physical units; or
a quantity of at least one item of transmit channels, antenna ports, or Multiple-Input Multiple-Output (MIMO) layers supported by at least one of the N physical units.

15. The method according to claim 14, further comprising:
receiving, by the network side device, capability information reported by the terminal;
determining, by the network side device, a correspondence between the target information and a parameter based on the capability information reported by the terminal; and
sending, by the network side device, the correspondence between the target information and the parameter to the terminal.

16. The method according to claim 14, wherein a quantity of transmit channels comprised or used by at least one of the N physical units meets at least one of the following:
a quantity of transmit channels comprised in a physical unit before transmit channel switching is equal to, greater than, or less than a ninth threshold;
a quantity of transmit channels used by a physical unit before transmit channel switching is equal to, greater than, or less than a tenth threshold;
a quantity of transmit channels comprised in a physical unit after transmit channel switching is equal to, greater than, or less than an eleventh threshold;
a quantity of transmit channels used by a physical unit after transmit channel switching is equal to, greater than, or less than a twelfth threshold;
a total quantity of transmit channels comprised in a physical unit before and after transmit channel switching is equal to, greater than, or less than a thirteenth threshold; or
a total quantity of transmit channels used by a physical unit before and after transmit channel switching is equal to, greater than, or less than a fourteenth threshold, wherein
the physical unit comprising a transmit channel represents a physical unit that has a transmit channel, and the physical unit using a transmit channel represents a physical unit that has a transmit channel and uses the transmit channel to send data.

17. The method according to claim 14, wherein the quantity of at least one item of transmit channels, antenna ports, or MIMO layers supported by the at least one of the N physical units meets at least one of the following:
a maximum quantity of transmit channels supported by the at least one physical unit is a sixteenth threshold;
a maximum quantity of antenna ports supported by the at least one physical unit is a seventeenth threshold; or
a maximum quantity of MIMO layers supported by the at least one physical unit is an eighteenth threshold.

18. The method according to claim 14, wherein the parameter comprises:
switching period information required for transmit channel switching, wherein the switching period information comprises at least one of the following: duration, a start time, or an end time.

19. The method according to claim 14, wherein
the physical unit comprises at least one of the following: a carrier, a bandwidth part BWP, a band, or a resource pool.

20. A terminal, comprising a processor and a memory storing instructions, wherein the instructions, when executed by the processor, cause the processor to perform operations comprising:
when the terminal performs transmission on at least one of the N physical units, determining a target parameter used for transmission or switching based on target information, wherein the transmission is transmission based on at least one of M transmit channels, N is an integer greater than 2, M is a positive integer less than or equal to N, and the target information comprises at least one of the following:
a transmit channel comprised or used by at least one of the N physical units; or
a quantity of at least one item of transmit channels, antenna ports, or Multiple-Input Multiple-Output (MIMO) layers supported by at least one of the N physical units.
